(19) United States
(12) Patent Application Publication
(10) Pub. No.: US 2009/0015665 A1
(43) Pub. Date: Jan. 15, 2009

(54) Medical diagnostic ultrasound video timing control

(76) Inventor: Todd D. Willsie, Seattle, WA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/827,695

(22) Filed: Jul. 13, 2007

(51) Int. Cl. H04N 7/18

(52) U.S. Cl. 348/77; 345/472; 345/87; 348/441; 348/E07.001; 348/E07.085; 348/E07.087

(57) ABSTRACT

Video signals are controlled in an ultrasound imaging. The line synchronization and/or frame rate may be set for any desired purpose, such as to match an acoustic scan rate. The pixel clock rate is set based on the line synchronization or frame rate. Since the line synchronization timing may not be an integer multiple of the pixel clock rate, the pixel clock may be controlled to maintain a state for additional system clocks.

### BACKGROUND

The present embodiments relate to medical diagnostic ultrasound imaging. In particular, video timing control is provided for medical imaging.

The video frame rate output by many ultrasound imaging systems is fixed. For example, images are output at 30 Hz or 60 Hz to simplify the conversion to NTSC standard video signals required by videocassette recorders. Matching the video frame rate to the frame rate used in common applications simplifies recording ultrasound scans. Off-the-shelf parts may be used for the video generation in the ultrasound system as well.

Data is read out for display at a pixel clock rate. For each line of pixels, line synchronization is provided. The pixel clock rate and the line synchronization timing may be fixed for a given display. For liquid crystal and other types of displays, the pixel clock rate and line synchronization timing may be programmed, such as programming the rate as part of the design of a system. However, ultrasound imaging systems provide limited control of the video pixel clock rate and frame rate.

### BRIEF SUMMARY

By way of introduction, the preferred embodiments described below include methods, systems, instructions, and computer readable media for controlling video signals in an ultrasound imaging. The line synchronization and/or frame rate may be set for any desired purpose, such as to match an acoustic scan rate. The pixel clock rate is set based on the line synchronization or frame rate. Since the line synchronization timing may not be an integer multiple of the pixel clock rate, the pixel clock may be controlled to maintain a state for additional system clocks.

In a first aspect, a method is provided for controlling video signals in ultrasound imaging. Line synchronization timing is set as a function of ultrasound beamforming. A pixel clock rate of a display is determined as a function of the line synchronization timing. A pixel clock is held where the line synchronization timing is not an integer multiple of the pixel clock rate.

In a second aspect, a system is provided for controlling video signals in an ultrasound imager. A system clock is operable to output system clock waveform at a system clock rate. A display has pluralities of pixel locations arranged in lines. A processor is operable to determine, as a function of a line synchronization rate, a number of system clock cycles of the system clock waveform for each cycle of a pixel clock waveform. Data for the display is read out to the display as a function of the pixel clock waveform.

In a third aspect, a computer readable storage medium has stored therein data representing instructions executable by a programmed processor for controlling video signals in ultrasound imaging. The storage medium includes instructions for setting the display line timing as a function of ultrasound beamforming tasks, determining pixel clock cycle as a function of the display line timing, and holding a pixel clock waveform as a function of any difference between the display line timing and the pixel clock cycle times a number of pixels in a line of the display.

The present invention is defined by the following claims, and nothing in this section should be taken as a limitation on those claims. Further aspects and advantages of the invention are discussed below in conjunction with the preferred embodiments.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a block diagram of one embodiment of an ultrasound imaging system for controlling video signals in ultrasound imaging; and

FIG. 2 is a flow chart diagram of one embodiment of a method for controlling video signals in ultrasound imaging.

### DETAILED DESCRIPTION OF THE DRAWINGS AND PRESENTLY PREFERRED EMBODIMENTS

A video clock signal with a line time that is not an integer multiple of the pixel clock may be generated. The line rate may be changed while the number of pixel clock cycles remains constant, satisfying the timing requirements of some liquid crystal displays. The line rate may adapt to other requirements than the display, such as triggering scanning based on the line rate. The line rate is set for scan timing. The pixel clock rate is adjusted to provide the desired number of pixel clock cycles. Where the line rate is not an integer multiple of the pixel clock, the pixel clock may be held in a state for a time sufficient to account of the difference.

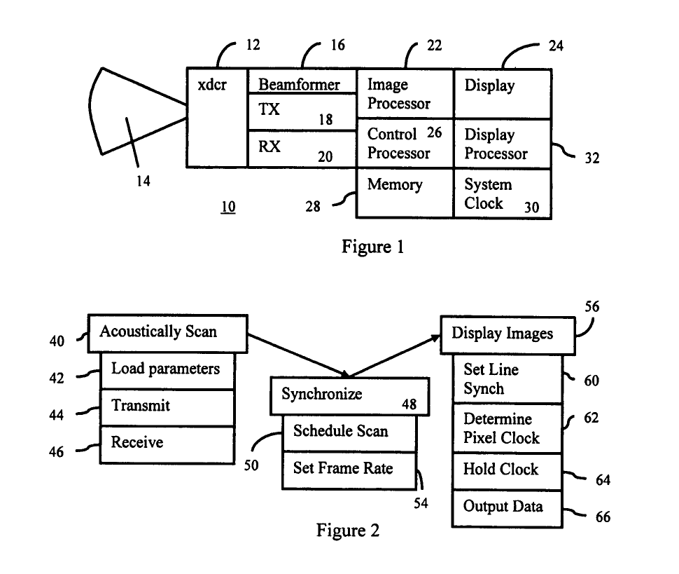

FIG. 1 shows one embodiment of a medical diagnostic ultrasound imaging system 10 for controlling video signals in an ultrasound imager. Any ultrasound imaging system 10 may be used. In one embodiment, the system 10 is a cart based imaging system. In another embodiment, the system 10 is a portable system, such as a briefcase-sized system or laptop computer based system. Other embodiments include handheld ultrasound systems. For example, one or more housings are provided where the entire system is small and light enough to be carried in one or both hands and/or worn by a user. Any weight may be provided, such as 1-15 pounds (e.g., 6 pounds or less). In one embodiment, the system weighs less than 2 pounds to minimize strain in carrying the system by a medical professional. A battery powers the system, and small-scale circuits, such as integrated circuits implement the electronics. In another example, a transducer is in one housing to be held by a person, and the imaging components and display are in another housing to be held by a person. Coaxial cables connect the two housings. A single housing for an entire handheld system may be provided.

The system 10 includes a transducer 12, a beamformer 16, an image processor 22, a display 24, a control processor 26, a memory 28, a system clock 30, and a display processor 32. Additional, different, or fewer components may be used. For example, a cable connects the transducer 12 to the beamformer 16, and/or a cable connects part of the display 24 (e.g., monitor or LCD) to another part of the display 24 (e.g., video card) or the image processor 22. The image processor 22, control processor 26, and/or display processor 32 may be combined as one processor or group of processors, or maintained separate as shown.

The elements connect directly to the beamformer 16. Alternatively, multiplexers provide for aperture control to connect elements to different channels at different times. To reduce a number of cables, the number of connections from the elements to the beamformer 16 may be reduced. Time multiplexing, frequency multiplexing, sub-array mixing, partial beamforming or other processes for combining signals may be used. For example, signals from groups of four or other numbers of elements are combined onto common data paths by sub-array mixing, such as disclosed in U.S. Pat. No. 5,573,001 or U.S. Published Application No. 20040002652, the disclosures of which are incorporated herein by reference.

The transducer 12 is an array of elements. Any array may be used, such as a linear, phased, curved linear, or other now known or later developed array. Any number of elements may be used, such as 64, 96, 128, or other numbers. One, two, or other multi-dimensional (e.g., 1.25, 1.5, or 1.75) arrays may be provided. The elements are piezoelectric or capacitive membrane elements.

In response to signals from the beamformer 16, the transducer 12 generates acoustic beams. The acoustic beams are focused to different locations to scan a two or three-dimensional region 14. The scan format is linear, sector, Vector®, or other now known or later developed scan format. The scan format includes a set or programmable number of beams within the region 14, such as 50-150 beams. The depth of the region 14 may be set or programmable.

The transmit portion 18 of the beamformer connects with electrodes on one side of the elements, and the receive portion 20 of the beamformer 16 connects with electrodes on an opposite side of the elements. Passive or active switching grounds the electrodes not being used, such as grounding transmit side electrodes during receive operation. Alternatively, the beamformer 16 connects to the transducer 12 through a transmit/receive switch.

The transmit and receive portions 18, 20 are formed in a same device or are separate. The transmit portion 18 is a transmit beamformer. The receive portion 20 is a receive beamformer.

The beamformer 16 is a digital beamformer. For digital beamforming, analog-to-digital converters sample the signals from the elements and output element data to the beamformer 16.

The beamformer 16 is an application specific integrated circuit, processor, field programmable gate array, digital components, integrated components, discrete devices, or combinations thereof. In one embodiment, the transmit portion 18 includes a plurality of pulsers or waveform generators, such as transistors, and amplifiers. The transmit portion 18 generates electrical signals for different elements of the transducer 12. The electrical signals have relative amplitude and delays for generating an acoustic beam along one or more scan lines.

In one embodiment, the receive portion 20 includes a plurality of delays and one or more summers for relatively delaying electrical signals received from the transducer elements and summing the delayed signals. Amplifiers may be provided for apodization. In one embodiment, the delays are implemented as memories for storing channel data. One or more memories may be used. For example, two memories operate in a ping-pong fashion to store data from elements and read data out for beamforming. Each memory stores element data for an entire scan and/or transmit/receive event. As one memory is storing, the other memory is outputting. By reading data out of the memory from selected memory locations, data associated with different amounts of delay is provided. The same data may be used for sequentially forming receive beams along different scan lines. Other memories may be used, such as a plurality of first-in, first-out buffers for delaying based on length and/or timing of input into the buffers.

The beamformer 16 operates pursuant to control parameters. The control parameters indicate the scan format, the number of beams to scan an entire region (beam count), a depth of scan, a pulse repetition frequency, a sample frequency (e.g., analog-to-digital sample rate), apodization profile, number of focal points or transmissions along a given line, number of parallel transmit and/or receive beams, delay profile, waveform shape, waveform frequency, or other characteristic of scanning performed by the beamformer 16. For each transmission and corresponding reception, scan of a region, or other period, new control parameters may be loaded. For example, a table of control parameters is used to download to the beamformer 16. The control parameters to be downloaded are selected as a function of user or processor selection of scan information. In alternative embodiments, one, more or all of the parameters are fixed.

Loading the parameter for scanning takes time, such as a particular number of clock cycles. Performing the scan also takes time, such as time for acoustic energy to propagate to the deepest depth of the region 14 and echoes to return to the transducer 12. Depending on the configuration, different amounts of time may be needed to scan the region 14. For example, a higher beam count, deeper depth, lower pulse repetition frequency, number of beams per transmit or receive, or other control parameter may result in scanning taking a longer time.

The timing of transmit and receive events may be set or variable. For example, a sequence of transmit and receive events are performed along a same scan line with a set amount of time between each. The fixed time is used to determine motion or flow information, such as Doppler processing.

The image processor 22 is a processor, detector, filter, scan converter, or combinations thereof. In one embodiment, the image processor 22 includes a B-mode and/or Doppler detectors. Intensity and/or motion information is detected from the receive beamformed information. Scan conversion converts from a scan format to a display format, such as from a polar coordinate format to a Cartesian coordinate format. Any now known or later developed image processor 22 and/or image processing may be used, such as an FPGA or application specific integrated circuit.

The display 24 is a liquid crystal display, monitor, plasma screen, projector, printer, combinations thereof, or other now known or later developed display device. The display 24 includes pixel locations arranged in rows. For example, each pixel location includes red, blue, and green light sources. The pixel locations are arranged in lines, such as vertical columns or horizontal rows. For a given use, the display 24 may be oriented with the columns or rows in vertical, horizontal or angular orientations.

The display 24 operates in response to timing provided by the display processor 32 to generate an image from data provided by the image processor 22. The display 24 receives scan converted ultrasound data and displays an image. For real-time ultrasound imaging, the display 24 receives frames of data and displays a sequence of ultrasound images each representing the region 14 or overlapping portions thereof. The sequence of ultrasound images are generated at a frame rate, such as 30 Hz or other rate. The rate is maintained or varies during the sequence. The data is provided to the display 24 sequentially by lines, with data for each pixel provided in response to a cycle of a pixel clock provided by the display processor 32.

In one embodiment, a buffer stores each frame of scan converted ultrasound data output from the image processor 22. A video processor outputs lines of display data in response to horizontal and/or vertical synchronization signals. The line synchronization signals trigger reading of the next row or column of information for display from the buffer. The video frame rate is responsive to or is based on the synchronization signal. More rapid video line synchronization signals provide a more rapid frame rate.

The display 24 is operable at different frame rates. The pixel clock for reading out of the buffer or reading to the screen and/or the line synchronization timing increases or decreases to alter the frame rate. Alternatively or additionally, holds or delays of different lengths are provided between reading pixels, lines or entire frames, such as delaying after or before every video line synchronization signal. Other hardware or software processes may be used for adjusting the frame rate.

The frame rate of the display 24 is adjusted as a function of operation of the beamformer 16. For example, the frame rate is adjusted to correspond to a scan rate or rate of operation for receive beamformation. The scan rate and the video frame rate are set equal, such that images are generated at a same rate as data for images is acquired. Other ratios may be used, such as generating the images at half or twice the scan rate (e.g., scan the region 14 once for each two images generated). Where the scan rate is slower (e.g., ½ the display frame rate), the same image may be generated twice.

The scan rate includes the time to configure the beamformer 16 with the control parameters, the time to transmit beamform based on the control parameters, and/or the time to receive beamform based on the control parameters. Additional, different, or fewer components may be included in the scan rate, such as including time to sequentially form multiple beams from the same received data. The scan rate may be based on the time to perform all operations to form a frame of beamformed data representing the entire region at a given time.

The control processor 26 is a general processor, digital signal processor, application specific integrated circuit, field programmable gate array, digital circuit, combinations thereof, or other now known or later developed control processor. The control processor 26 is separate from or the same as the image processor 22. In one embodiment, the control processor 26 is a single device. In other embodiments, the control processor 26 includes a plurality of devices, such as distributed processors. The control processor 26 may be part of the beamformer 16, such as the control processor 16 controlling the loading and configuration of the beamformer 16, and/or part of the display processor 32, such as the control processor 26 controlling the video frame rate. Alternatively, the control processor 16 controls beamforming and/or video control processors.

The control processor 26 determines beamformer operation timing and schedules the beamformer operation relative to the video frame rate. The loading of control parameters, transmit operation, and receive operation are scheduled. Based on the beamformer configuration, different amounts of time may be needed to scan the region 14 for a frame of data. The depth, beam count, and sample frequency may increase or decrease the amount of time needed to complete a scan. For example, a high sample frequency may over run the delay memory. Accordingly, multiple scans are performed with different focal depths (e.g., a near scan and a far scan) to scan the entire region 14 without over flowing the delay memory of the receive portion 20. As another example, scanning 60 scan lines takes less time than scanning 100 scan lines. In another example, scanning to 10 cm takes less time than scanning to 20 cm.

The video frame rate is adjusted to account for the time to complete the scanning schedule. The video frame rate is adjusted to be the same or substantially same as the scan rate. Alternatively, the video frame rate is adjusted to be at a desired ratio to the scan rate.

In one embodiment, the scheduled scanning tasks are scheduled relative to the video frame rate. For example, control parameters may be loaded in an amount of time to read out one line of video (e.g., between video line synchronization signals). Eight or other number of lines of video may be read out in the amount of time to transmit and receive in one event. Given hundreds of lines of data for an image and the corresponding hundreds of line synchronization signals, different scanning tasks are scheduled to occur with different video lines. The scheduled operations are performed to provide a complete scan in a desired number of video lines, such as sufficient lines for one or more complete images.

In one embodiment, the video line signal of the display 24 is received as an interrupt by the control processor 26 or a beamformer controller. This interrupt locks the scanning operation to the line synchronization of the display. Scanning, scanning configuration, overlay video, and/or another process are scheduled to occur based on the line synchronization, so the line synchronization triggers the next scanning task. Other synchronization triggers may be used, such as counting clock pulses or triggers output by the beamformer 16. For example, the video line synchronization signal is triggered based on completion of beamformer tasks in the schedule.

The system clock 30 is a crystal oscillator, phase-locked loop, or other now known or later developed clock. The system clock 30 outputs a sinusoidal or square wave at a desired frequency—the system clock rate. For example, the system clock 30 outputs a binary signal at 40-100 MHz. Multiple system clocks may be provided at the same or different frequencies.

The display processor 32 is a same or different type of processor than the control processor 26. For example, the display processor 32 is a field programmable gate array, application specific integrated circuit, general processor, digital signal processor, or other processing device. In other embodiments, the display processor 32 is a video card, video buffer, or other circuit. The display processor 32 operates as a state machine, but other processing may be provided. The state machine is provided as a hardware, firmware, software, or combinations thereof.

The display processor 32 generates the pixel clock waveform and the line synchronization timing signal. The buffer for providing data to the display 24 is implemented by the display processor 32 or is part of the display 24. The display data is output from the buffer in response to a rising, falling, or both rising and falling edges of the pixel clock waveform. For each trigger event, data for a next pixel in a line is read out. After the line is complete or at the start of a line, the line synchronization timing signal is generated to trigger output to the next line of the display 24.

The display processor 32 determines the number of system clock cycles of the system clock waveform for each cycle of a pixel clock waveform. The display processor 32 determines the line synchronization rate. The determination is made in the same device implementing the generation of the waveforms or a different device. For example, the control processor 26 implements determination as part of the display processor 32.

The number of system clock cycles for each cycle of the pixel clock waveform is determined as a function of the line synchronization rate and/or video frame rate. A given number of pixels are provided in each line based on the display 24. Given a line synchronization rate, the number of system clock cycles to provide pixel clock cycles sufficient to trigger output of the number of pixels in the line is determined. For example, the line synchronization rate is once every 2,304 system clock cycles. For 768 pixels, the number of system clock cycles for each cycle of the pixel clock waveform is 3. Every third system clock cycle, a pixel clock cycle is completed or starts. The pixel clock rate is set to ⅓ the system clock rate. The pixel clock rate allows for the data for one line of pixels to be read out to the display in one cycle of the line synchronization rate without extra pixel clock cycles.

If the line synchronization rate is not an integer multiple of the pixel clock rate, the pixel clock waveform may be held. For example, the line synchronization rate is once every 2,400 system clock cycles. The pixel clock cycle is determined to be ⅓ the system clock cycle as shown above. Clocking pixels every third system clock cycle provides sufficient number of pixel clock cycles during the line. However, extra system clock cycles result (e.g., 96 in this example). Setting the pixel clock rate to ¼ the system clock rate would not read a sufficient number of pixels within the line timing. To deal with the extra system clock cycles, the pixel clock waveform is held, such as in a low or high state for the extra system clock cycles. The hold may be a single period or multiple periods. The period or periods for holding may be at the start, end, and/or within the pixel clock waveform for the line. In one embodiment, every other cycle for a certain number of cycles has a hold of one, more, or a fraction of a system clock cycle. In another embodiment, the hold is after the last pixel in a line has been clocked and until the next line synchronization signal. To minimize the hold, the maximum number of system clock cycles for each pixel clock cycle to provide the desired number of pixels is used.

The line synchronization timing or rate is determined as a function of ultrasound beamforming timing. The line synchronization is set to allow for completion of the scheduled beamforming tasks. The tasks are divided into equal temporal increments based on a correlating or matching line synchronization rate. Alternatively, given a desired frame rate, the timing for each line is determined.

The display processor 32 provides for changes in the line synchronization rate. For example, different beamformer parameters are set. As a result, the line synchronization timing is adjusted to be longer or shorter. The pixel clock rate and any holds are determined in response to the change in the line synchronization rate.

The memory 28 is a computer readable storage medium having stored therein data representing instructions executable by a programmed processor for controlling video signals in ultrasound imaging. The instructions for implementing the processes, methods and/or techniques discussed herein are provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like.

In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU or system. In another embodiment, the memory 28 is within a handheld ultrasound system with one or more housings. The handheld ultrasound system includes the beamformer 16 and the display 24.

FIG. 2 shows a method for controlling video signals in ultrasound imaging. The method is implemented by the system 10 of FIG. 1, a handheld system with one or more housings, or a different system. In one embodiment, the method is implemented as signal processing performed with custom digital logic implemented in field programmable gate arrays. The method is performed in the order shown or a different order. Additional, different, or fewer acts may be performed.

In act 40, a region is scanned with ultrasound. To scan, values of control parameters are loaded or calculated in act 42. The control parameters indicate the depth, scan format, number of beams, sample frequency, pulse repetition frequency, focal regions, combinations thereof, or other programmable beamforming characteristic. One or more characteristics may be fixed or not programmable.

After loading values for the control parameters, one or more transmit events are performed in act 44. The transmit event includes the generation of electrical signals. The electrical signals are converted by a transducer into acoustic energy. Based on the control parameters, the acoustic energy forms one or more beams. A plane wave or diverging wave may be formed in other embodiments.

One or more receive events are performed in act 46. In response to the transmit beam or beams of act 44, echoes impinge on the transducer. In the receive event, the echoes are converted to electrical signals by the elements. The electrical signals are beamformed. Relative delays and/or apodization are applied and the data summed. Data representing one or more receive beams is formed from the same electrical signals.

To scan an entire region, the transmit and receive events may be repeated. Alternatively, a plane wave is transmitted and all or groups of receive beams are formed in response to each transmission. For subsequent transmit and receive events, the same parameters may be used without further loading of control parameters. Alternatively, new parameters are calculated or loaded for each beam, group of beams, or portion of a scan. The scanning of act 40 is performed pursuant to a schedule of events. The schedule includes the loading, transmitting and receiving to scan a region. The region is an entire two or three-dimensional region for generating an image. Alternatively, the scheduling is performed for sub-regions less than the entire region to be scanned. The schedule may be repeated for a sequence of scans, such as until the user indicates different scanning to be performed (e.g., a different depth).

In act 56, images are generated with ultrasound information. Beamformed ultrasound data is detected, scan converted, or otherwise formed into image data. The image data is output for display. For real-time operation, the scanning of act 40 and the displaying of act 56 occur substantially simultaneously. Substantially accounts for data processing delays and pauses to load control parameters. Frames of beamformed data are sequentially and substantially continuously acquired by scanning in act 40. The frames of data after image processing are sequentially and substantially continuously displayed as images in the displaying of act 56. The displaying of the sequence occurs at a constant or variable frame rate.

The frame rate of the images is synchronized with the scanning in act 48. The frame rate of the displaying of act 56 is adjusted. The adjustment is based on the scan or acoustic rate, such as the time to perform the loading, generating and receive beamforming of the scanning in act 40. The display frame rate is a function of the scheduled beamforming activities. The display frame rate may be set for given scanning configuration and expected scan rate, but remain the same despite variance in the scan rate. Alternatively, as the scan rate varies, the display frame rate also varies.

In act 50, the scanning operations are scheduled. The schedule is calculated or determined prior to scanning of act 40 and/or in response to user input. The schedule is based on the scanning to be performed and the hardware used to perform the scanning. An amount of time to complete the scanning of the region is determined. The amount of time includes the loading of control parameters in act 42, the transmitting in act 44, the receiving in act 46, any delay between transmit/receive events (e.g., delays for Doppler imaging), and/or combinations thereof.

The schedule includes the various operations to occur for scanning. An amount of time needed for each operation is known or may be calculated. For example, the amount of time for transmitting and receiving is, at least in part, calculated based on the depth to be scanned. The load time for control parameters may be determined in advance from the hardware design or is assumed. Given the scan format, the number of beams to be formed is determined or known. The sample frequency may dictate multiple scanning of sub-regions (e.g., dual focal zones for each scan line). Doppler imaging may require multiple scans of the same scan lines. The operations to complete the scan are determined.

The operations are provided in a sequence and scheduled based on time. Any division may be used, such as cycles, clock counts, or time. In one embodiment, the operations are divided based on time for displaying each video line or between display synchronization signals.

In act 54, the video or display frame rate is set or mapped to the scan rate. The schedule indicates the time to complete a scan. The scan rate is determined from the time. The time to complete a scan is determined from the schedule. The frame rate of the display is set to be the same as the scan rate. The display frame rate is set to correspond to or provide sufficient time for performing the scanning of act 40. The images are of an entire region. The scan to provide data for the entire region is performed repetitively at an acoustic scan rate. The display frame rate is adjusted to be the same or substantially the same as the acoustic scan rate.

For real-time operation, the display is provided with frames of data at the rate at which the frames of data are acquired. Extra buffering or changing the scan rate may be avoided. The scan rate rather than display frame rate determines the rate of operation of the system.

In alternative embodiments, the acoustic scan rate is different than the display frame rate. The display frame rate is a function of the acoustic scan rate, but may be double or other integer multiple of the acoustic scan rate. For example, the same image is displayed two or more times to provide sufficient time to scan the entire region to be imaged in later displayed images. If the scan rate is 18 Hz, but the lowest acceptable display frame rate is 20 Hz, then the display frame rate is set to 36 Hz. At twice the scan rate, the newest available images are displayed when available, but each is displayed twice in succession.

The synchronization is provided by setting the video timing as a function of the schedule or time to complete the schedule. In one embodiment, the scheduled tasks are divided into stages corresponding to video line synchronization signals. Each task uses the time for one or more video lines to be output. The processor implements the acoustic scanning tasks based on the video line signals. As each video line signal or after a count of a certain number of video line signals is received, the next task in the schedule is implemented. In alternative embodiments, the scanning and display are not further synchronized other than the setting of the rates.

The transmit and receive events and other beamforming actions are triggered with the line synchronization timing. For implementing the schedule, the display processor 32 outputs the line synchronization signal. The tasks in the schedule are performed in response to the line synchronization or display line timing. Part of the schedule may provide for a set time between transmissions and/or receptions, such as associated with transmitting a Doppler pulse sequence along a scan line. During this set time, no action or loading of parameters is performed.

Given the beamforming to be completed, the frame rate is determined. Given the number of display lines, a line synchronization or display line timing is set based on the desired video frame rate or beamforming schedule in act 60. For example, the line synchronization signal is desired every M system clock cycles. The M system clock cycles times the number of display lines provide for sufficient time to scan with the ultrasound system. Between each line synchronization signal of the display 24, M system clock cycles pass. During the M system clock cycles for every line of the display 24, the scheduled beamforming task occurs. For example, one period of M system clock cycles, multiple lines, or a fraction thereof provides for a set period between transmissions for Doppler processing.

The display line timing provides sufficient time to read out the line of the pixels for the display 24 and to perform the ultrasound beamforming tasks scheduled for the line. One or more beamforming tasks may be associated with multiple line signals. The line synchronization timing provides for completion of each transmit and receive event with the set time between transmissions.

In act 62, the pixel clock rate of the display is determined as a function of the line synchronization or display line timing. A number N of system clock cycles sufficient to output data for a line of O pixels of the display within M system clock cycles is determined. N is the pixel clock rate in number of system clock cycles, M is the line synchronization rate in number of system clock cycles, and O is the number of pixels in a line on the display. O is for a full or partial line. The number M of system clock cycles in the display line timing is divided by the number O of pixels in the line. To provide an integer multiple of pixel clock cycles within the display line timing, the result of the division is rounded down. In alternative embodiments, an even higher pixel clock rate or fewer number of system clock cycles per cycle of the pixel clock waveform is used.

In act 64, any hold or holds in the pixel clocking are determined. If the line synchronization timing is not an integer multiple of the pixel clock rate, then a hold is determined. During the holding, data is not output for one or more cycles of a system clock to allow for completion of the line synchronization timing and read out of a line of pixels without clocking further pixels. The pixel clock is held for a number of system clock cycles representing a difference between M and NxO, the difference between the display line timing and the pixel clock cycle times a number of pixels in a line of the display.

For example, an LCD pixel clock cycle is N system cycles, but the total time for each video line is M system cycles. The state machine generating the pixel and line synchronization waveforms receives parameters for the LCD clock rate (pixel clock rate) in units of system clock cycles, the line quantization clock cycles (system cycles in a line), and the number of pixels per line. The state machine outputs the pixel clock cycles at the frequency indicated by the parameter. The last pixel clock cycle is extended to avoid reading out or attempting to read out extra pixels. The total time for each video line equals the total time to read out the pixels of the line with any extension while allowing for different or programmable line synchronization timing.

In act 66, data for each pixel in a line is output on a liquid crystal display at the pixel clock rate. In response to each rising, falling, or both edges of the pixel clock waveform, data for a pixel is read out. The number of pixels read out is equal to the number of pixels in the line. In response to the line synchronization signal, the pixels for the next line are read out.

The line synchronization timing may be changed, such as changing in response to a change in beamforming. A different scan rate may result from a change in beamforming. By matching the video rate to the scan rate, the video rate also changes. The line synchronization timing changes based on the video rate. The determination of the pixel clock rate is performed again in response to the change of the line synchronization timing such that a number of pixel clock cycles remains constant for each line.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (we) claim:

1. A method for controlling video signals in ultrasound imaging, the method comprising:
setting a line synchronization timing as a function of ultrasound beamforming;
determining a pixel clock rate of a display as a function of the line synchronization timing; and
holding a pixel clock where the line synchronization timing is not an integer multiple of the pixel clock rate.

2. The method of claim 1 further comprising:
outputting data for each pixel in a line on a liquid crystal display at the pixel clock rate;
wherein holding comprises not outputting data for one or more cycles of a system clock to allow for completion of the line synchronization timing.

3. The method of claim 1 wherein setting comprises setting the line synchronization timing to provide a set time between transmissions of acoustic energy.

4. The method of claim 3 further comprising:
triggering the transmit and receive events with the line synchronization timing;
wherein setting comprises:
determining a number of display lines for each transmit and receive event;
setting the line synchronization timing to provide for completion of each transmit and receive event with the set time between transmissions.

5. The method of claim 1 wherein the line synchronization timing comprises a line signal of the display every M system clock cycles;
wherein determining the pixel clock rate comprises determining a number N of system clock cycles sufficient to output data for a line of O pixels of the display within M system clock cycles, the pixel clock rate comprising N; and
wherein holding comprises holding the pixel clock for a number of system clock cycles representing a difference between M and NxO.

6. The method of claim 1 further comprising:
changing the line synchronization timing in response to a change of beamforming;
repeating the determining of the pixel clock rate in response to the change of the line synchronization timing such that a number of pixel clock cycles remains constant.

7. The method of claim 1 wherein setting the line synchronization timing comprises setting as a function of ultrasound beamforming in a handheld ultrasound system weighing less than 6 pounds; and
wherein the display is within or on the handheld ultrasound system.

8. A system for controlling video signals in an ultrasound imager, the system comprising:
a system clock operable to output system clock waveform at a system clock rate;
a display having pluralities of pixel locations arranged in lines; and
a processor operable to determine a number of system clock cycles of the system clock waveform for each cycle of a pixel clock waveform, data for the display read out to the display as a function of the pixel clock waveform, the determination being a function of a line synchronization rate.

9. The system of claim 8 wherein the processor comprises a state machine.

10. The system of claim 8 wherein the display comprises a liquid crystal display.

11. The system of claim 8 comprising a handheld ultrasound system weighing less than six pounds.

12. The system of claim 11 wherein the handheld ultrasound system weighs two or fewer pounds.

13. The system of claim 8 wherein the processor is operable to determine the line synchronization rate as a function of ultrasound beamforming timing.

14. The system of claim 13 wherein the processor is operable to schedule beamforming tasks, determine the line synchronization rate as a function of the beamforming tasks, and determine the number of system clock cycles for each cycle of the pixel clock waveform such that the data for one line of pixels is read out to the display in one cycle of the line synchronization rate;
the processor further operable to hold the pixel clock waveform for a difference between a time to read out the data for the one line and a time of one cycle of the line synchronization rate.

15. The system of claim 8 wherein the processor is operable to change the line synchronization rate in response to a change in beamforming, and operable to change the number in response to the change in the line synchronization rate.

16. In a computer readable storage medium having stored therein data representing instructions executable by a programmed processor for controlling video signals in ultrasound imaging, the storage medium comprising instructions for:
setting the display line timing as a function of ultrasound beamforming tasks;
determining pixel clock cycle as a function of the display line timing; and
holding a pixel clock waveform as a function of any difference between the display line timing and the pixel clock cycle times a number of pixels in a line of the display.

17. The instructions of claim 16 wherein setting the display line timing comprises setting the display line timing to be M system clock cycles between each line synchronization signal of a display.

18. The instructions of claim 16 further comprising:
triggering the ultrasound beamforming tasks with the display line timing, the tasks scheduled to provide a set time between transmissions;
wherein setting the display line timing comprises setting the display line timing to provide sufficient time to read out the line of the pixels and perform the ultrasound beamforming tasks scheduled for the line.

19. The instructions of claim 16 wherein determining comprises dividing a number of system clock cycles in the display line timing by the number of pixels in the line and rounding down to provide an integer multiple of pixel clock cycles within the display line timing.

20. The instructions of claim 19 wherein holding comprises holding for a number of system clock cycles.
